(19) United States
(12) Patent Application Publication
(10) Pub. No.: US 2021/0221017 A1
(43) Pub. Date: Jul. 22, 2021

(54) ULTRASONIC PUNCHING APPARATUS AND ULTRASONIC PUNCHING METHOD

(71) Applicant: MARUYA TEXTILE CO., LTD., Fukui (JP)

(72) Inventors: Harumi YAGI, Fukui (JP); Kozo TANAKA, Fukui (JP)

(73) Assignee: MARUYA TEXTILE CO., LTD., Fukui (JP)

(21) Appl. No.: 16/498,709

(22) PCT Filed: Jan. 9, 2019
(86) PCT No.: PCT/JP2019/000417

§ 371 Date: Sep. 27, 2019

(30) Foreign Application Priority Data
Jul. 30, 2018 (JP) 2018-142626

(51) Int. Cl. B26D 7/08; B26D 7/18; B26F 1/08; B26F 3/00

(52) U.S. Cl. CPC B26D 7/086; B26F 3/00; B26F 1/08; B26D 7/18

(57) ABSTRACT

Peripheral surfaces of holes formed are fixed in place and processed sheet is obtained in a state where the hole pattern is formed accurately. The apparatus is provided with a die on a surface of which are formed projecting parts corresponding to a hole pattern to be added to a processed sheet, an ultrasonic horn provided facing the die and outputting an ultrasonic wave toward a surface of the die, and a conveyor mechanism superposing over the processed sheet a resin sheet for melt bonding with and recovering pieces of the processed sheet punched out from the holes, passing the sheets between the die and the ultrasonic horn, and separating the resin sheet and the processed sheet after passage.

### TECHNICAL FIELD

This invention relates to an ultrasonic punching apparatus and ultrasonic punching method.

### BACKGROUND ART

In the past, as a technique for forming holes in a fabric sheet to create a pattern, the technique of forming holes by mechanical pressure was adopted.

For example, Document 1 discloses to press a punching member having blade parts against a sheet member to form holes and to recover the punched out pieces produced by forming the holes by suction.

Further, Document 2 discloses to punch holes in a textile fabric coated with a resin material by punching using a die with sharp edges.

Furthermore, Document 3 discloses a nonwoven fabric in which holes are formed.

### PRIOR ART DOCUMENT

### Patent Document

Patent Document 1: WO2013/190643

Patent Document 2: Japanese Unexamined Patent Publication No. 2000-144586

Patent Document 3: Japanese Unexamined Patent Publication No. 2003-140156.

### SUMMARY OF THE INVENTION

### Problems to be Solved by the Invention

The invention of Document 3 relates to nonwoven fabric, so does not require special modification to form holes. This art is not suitable for application to usual fabric sheets to prepare fabric sheets having hole patterns.

The inventions of Document 1 and Document 2 use mechanical pressure to form holes, so yarn-like debris sticks out from the circumferential surfaces of the formed holes. This not preferable aesthetically. Not only this, there was a problem of the debris sticking to clothing when contacting the same.

Further, when punching, the punched out pieces remaining after the processing have to be recovered. In Document 1, suction has to be used for recovery.

The present invention was made in consideration of the problems when punching holes in such a processed sheet and has as its object to provide an ultrasonic punching apparatus and ultrasonic punching method where the circumferential surfaces of the holes formed are immobilized and a processed sheet can be obtained in the state with the hole pattern formed accurately.

### Means for Solving the Problems

The ultrasonic punching apparatus according to the present invention comprises a die on a surface of which are formed projecting parts corresponding to a hole pattern to be added to a processed sheet, an ultrasonic horn provided facing the die and outputting an ultrasonic wave toward a surface of the die, a punching part superposing over the processed sheet a resin sheet for melt bonding with and recovering pieces of the processed sheet punched out from the holes, passing the sheets between the die and the ultrasonic horn, and outputting an ultrasonic wave from the ultrasonic horn toward the die to perform punching, and a conveyor mechanism separating the resin sheet and the processed sheet after passage.

In the ultrasonic punching apparatus according to the present invention, the apparatus further comprises a drive source driving the ultrasonic horn so that die, to the ultrasonic waves output toward the projecting parts of the die, the portions corresponding to the projecting parts of the die are melted through in a hole pattern, the tips of the projecting parts of the die are thin substantially rod shaped, and the ends are configured flat.

In the ultrasonic punching apparatus according to the present invention, a plurality of sets of a basic length die of a length shorter than a width of the processed sheet and an ultrasonic horn of a length corresponding to this basic length die are arranged aligned in a width direction of the processed sheet.

In the ultrasonic punching apparatus according to the present invention, the sets of the basic length die and the ultrasonic horn are arranged zigzag in a direction in which the processed sheet is conveyed.

In the ultrasonic punching apparatus according to the present invention, the apparatus further comprises a tension adjusting means provided with a rotating mechanism using a chain connected to a drive shaft to make the basic length die rotate and adjust a tension of the chain.

In the ultrasonic punching apparatus according to the present invention, positional control of the die or the basic length die and the ultrasonic horn is performed by snaking the ultrasonic horn move in a state where the die or the basic length die is immobilized.

In the ultrasonic punching apparatus according to the present invention, a plurality of the basic length dies are combined in a length direction to form an NX length die.

In the ultrasonic punching apparatus according to the present invention, as the ultrasonic horn, a plurality of sectional ultrasonic horns having ultrasonic output tips shorter than the ultrasonic output tip length of the ultrasonic horn are arranged corresponding to the basic length die.

In the ultrasonic punching apparatus according to the present invention, boundaries of divided sectional ultrasonic horns are formed as slanted surfaces.

An ultrasonic punching method according to the present invention comprises running between a die on a surface of which are formed projecting parts corresponding to a hole pattern to be added to a processed sheet and an ultrasonic horn provided facing the die and outputting an ultrasonic wave toward a surface of the die, a resin sheet for melt bonding with and recovering pieces of the processed sheet punched out from the holes superposed on the processed sheet, outputting an ultrasonic wave from the ultrasonic horn toward the die to perform punching when the superposed processed sheet and resin sheet are passed between the die and the ultrasonic horn, and separating the resin sheet and the processed sheet after passing between the die and the ultrasonic horn.

In the ultrasonic punching method according to the present invention, the method further comprises driving the ultrasonic horn so that due to the ultrasonic waves output toward the projecting parts of the die, the portions of the sheet corresponding to the projecting parts of the die and the corresponding portions of the resin sheet are malted through in a hole pattern.

In the ultrasonic punching method according to the present invention, the method further comprises arranging a plurality of sets of a basic length die of a length shorter than a width of the processed sheet and an ultrasonic horn of a length corresponding to this basic length die aligned in a width direction of the processed sheet and outputting ultrasonic waves from the respective ultrasonic horns toward the surfaces of corresponding basic length dies.

In the ultrasonic punching method according to the present invention, as the ultrasonic horn, a plurality of sectional ultrasonic horns having ultrasonic output tips shorter than the ultrasonic output tip length of the ultrasonic horn are arranged corresponding to the basic length die.

### Effect of the Invention

According to the present invention, the circumferential surfaces of the holes formed are immobilized and it is possible to obtain a processed sheet in the state with the hole pattern formed accurately.

### BRIEF DESCRIPTION OF THE DRAWINGS

FIG. 1 is a view of the overall configuration of an ultrasonic punching apparatus according to an embodiment of the present invention;

FIG. 2 is a view showing an arrangement of dies of an ultrasonic punching apparatus according to an embodiment of the present invention;

FIG. 3 is a perspective view showing one example of a die of an ultrasonic punching apparatus according to an embodiment of the present invention;

FIG. 4 is a perspective view showing examples of a projecting part formed on a die of an ultrasonic punching apparatus according to an embodiment of the present invention;

FIG. 5 is a cross-sectional view of examples of a projecting part formed on a die of an ultrasonic punching apparatus according to an embodiment of the present invention;

FIG. 6 is a plan view of several projecting parts formed on a die of an ultrasonic punching apparatus according to an embodiment of the present invention;

FIG. 7 is a perspective view showing one example of an ultrasonic horn of an ultrasonic punching apparatus according to an embodiment of the present invention;

FIG. 8 is a view showing a configuration of positional adjustment between a die and an ultrasonic horn in an ultrasonic punching apparatus according to an embodiment of the present invention;

FIG. 9 is a plan view showing positional deviation of holes of a hole pattern;

FIG. 10 is an explanatory view of a mechanism for preventing positional deviation of holes of a hole pattern in an ultrasonic punching apparatus according to a second embodiment of the present invention;

FIG. 11 is a cross-sectional view showing an example of an NX length die used in an ultrasonic punching apparatus according to a second embodiment of the present invention;

FIG. 12 is a cross-sectional view along A-A of FIG. 11;

FIG. 13 is a front view showing an example of an ultrasonic horn configured by sectional ultrasonic horns used in an ultrasonic punching apparatus according to the second embodiment of the present invention;

FIG. 14 is a front view of the configuration of part of the ultrasonic horn and die of an ultrasonic punching apparatus according to a third embodiment of the present invention; and

FIG. 15 is a front view of the configuration of the portion of the ultrasonic horn and die of FIG. 14 assuming an ultrasonic horn side from a center of a shaft of the die.

### EMBODIMENT OF THE INVENTION

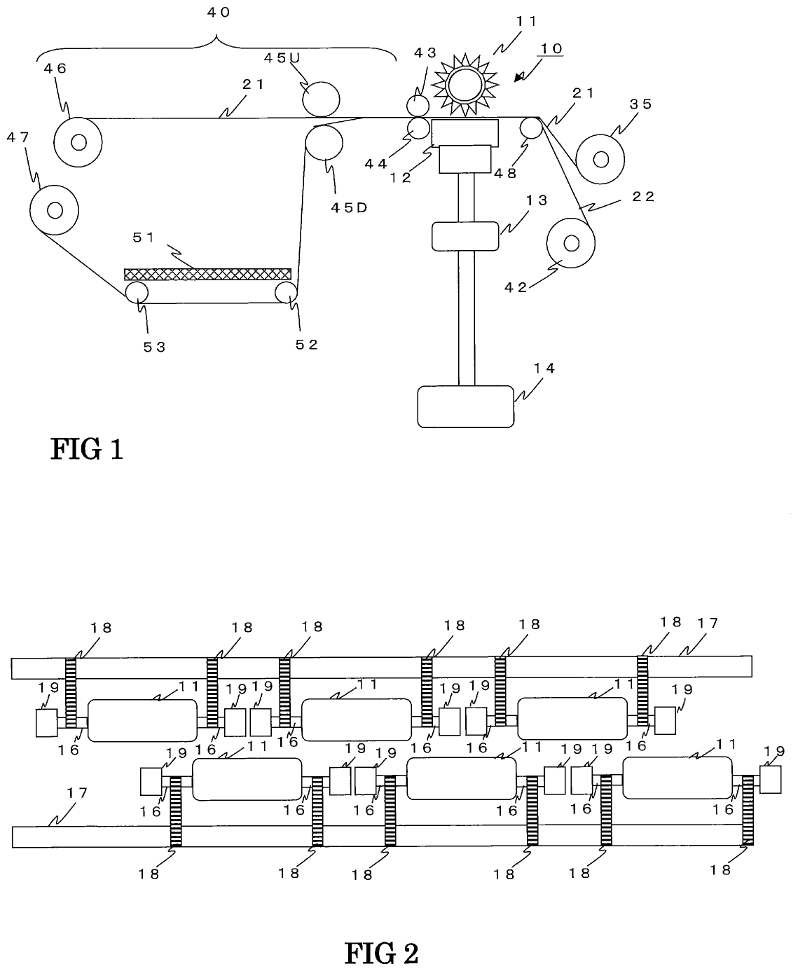

Below, referring the attached drawings, embodiments of the ultrasonic punching apparatus and ultrasonic punching method according to the present invention will be explained. In the figures, the same component elements are assigned the same reference notations and overlapping explanations are omitted. FIG. 1 is a view of the overall configuration of an ultrasonic punching apparatus according to a first embodiment. In this first, embodiment, a basic length die 11 of a length shorter than the width of the processed sheet 21 is used. The length of this basic length die 11 is for example 40 cm. The width of the processed sheet 21 is for example 150 cm or less. These lengths are just illustrations. Other lengths are also possible of course.

The ultrasonic punching apparatus is provided with a punching part 10 passing a processed sheet 21 and a resin sheet. 22 between a basic length die 11 and ultrasonic horn 12 to punch them. At the ultrasonic horn 12, an oscillator 13 is connected so as to make the ultrasonic horn 12 oscillate and output an ultrasonic wave from the ultrasonic horn 12. At the oscillator 13, an ultrasonic transducer 14 sending high frequency electric power of a predetermined frequency to the oscillator 13 is connected. The processed sheet 21 can be made a sheet of fabric, leather, paper, etc. Further, the resin of the resin sheet 22 may be made an OPP film (polypropylene film).

A plurality of the above dies 11, as shown in FIG. 2, are arranged in the width direction of the processed sheet 21. Further, the basic length dies 11 are arranged zigzag in the direction in which the processed sheet 21 is conveyed. The basic length dies 11 are arranged zigzag slightly overlapping at their end parts and are configured so that the hole patterns formed at the processed sheet 21 are continuous. A shaft 16 is passed through each basic length die 11 Further, a long drive shaft 17 arranged so as to straddle the basic length dies 11 is turned by a not shown motor. The drive shaft 17 and the shafts 16, 16 at the two end parts of the basic length dies 11 have gears. The gears are driven linked by the chains 18, 18. 19 indicates a bearing of the shaft 16 and is for example fixed to a not shown main body.

The basic length dies 11 are provided corresponding to ultrasonic horns 12 having lengths of substantially the same extent as the basic length dies 11 (length of processed sheet 21 in width direction) below the basic length dies 11. Therefore, in the width direction of the processed sheet 21, a plurality of sets of the basic length die 11 and the ultrasonic horn 12 are provided aligned. Further, the sets of the basic length die 11 and the ultrasonic horn 12 are provided arranged zigzag in the direction in which the processed sheet 21 is conveyed.

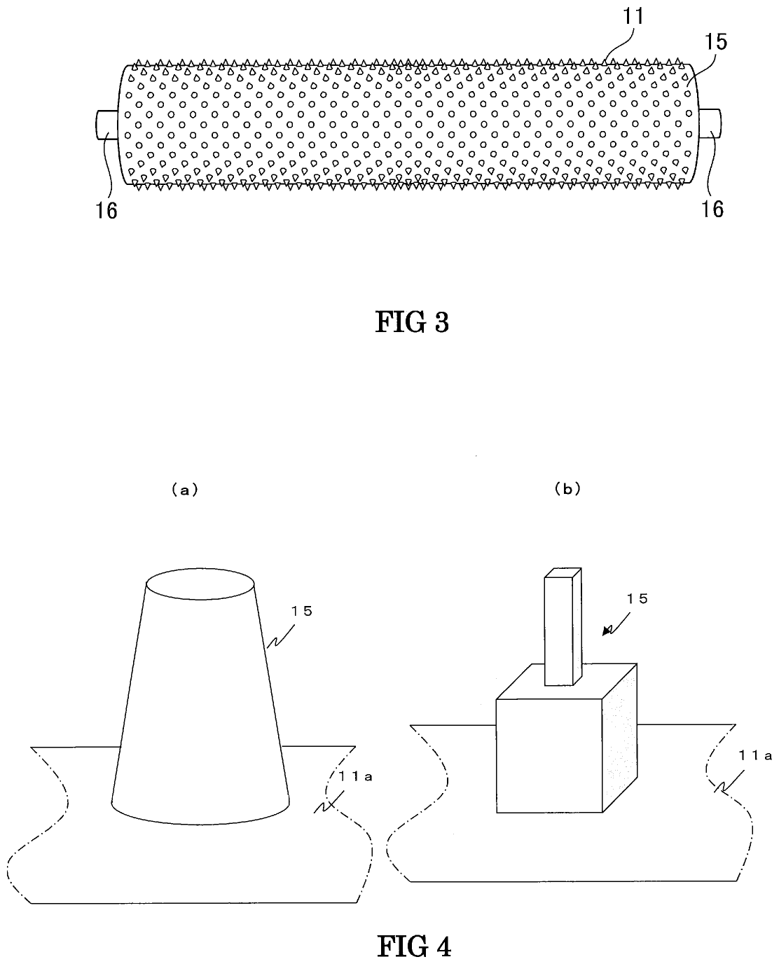

A basic length die 11, as shown in FIG. 3, is cylindrically shaped and is used in a state where a cylinder is made horizontally long. The projecting parts 15 corresponding to the hole pattern to be added to the processed sheet 21 are formed on the surface of the basic length die 11. In the present embodiment, the apparatus is provided with a drive source driving the ultrasonic horn 12 so that the ultrasonic waves output toward the surface, including the projecting parts 15 of the basic length die 11, cause the portions of the processed sheet 21 corresponding to the portions of the projecting parts 15 of the basic length die 11 to be melted through in the hole pattern. This drive source is constituted by the oscillator 13 and ultrasonic transducer 14 of FIG. 1.

The projecting parts 15 have tips of thin substantially rod shapes. As shown in FIG. 4(a), a basic length die 11 is formed from the base surface 11a to the tip in a thin truncated conical shape or truncated pyramidal shape. Alternatively, as shown in FIG. 4(b), it may be comprised of a plurality of circular columnar or square columnar shapes of different sizes or thicknesses stacked together.

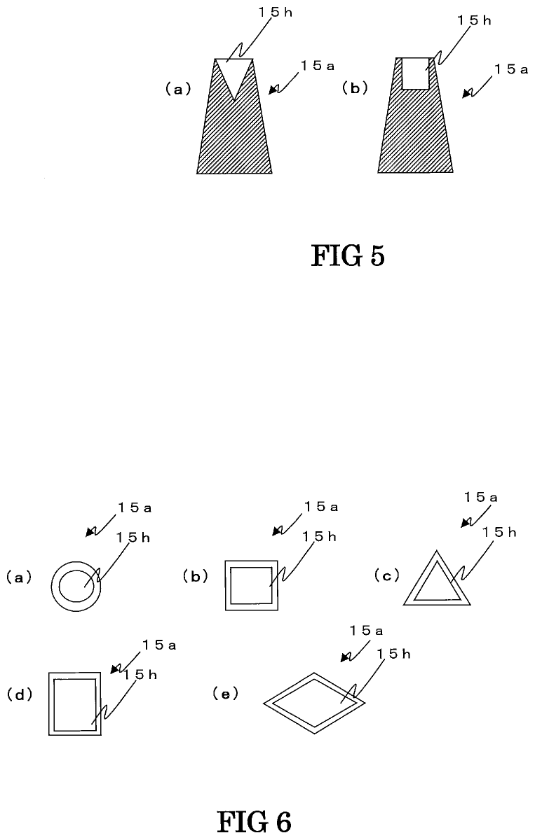

Further, when viewing the end part 15a from above, as shown in FIG. 5, it is possible to configure the apparatus so has to have a recessed part 15h at the center of the top part of the end part 15a. The tip at the circumferential wall of the recessed part 15h shown in FIG. 5(a) is sharp, while the tip at the circumferential, wall of the recessed part 15h shown in FIG. 5(b) is flat. The configuration of the recessed part 15h shown in FIG. 5(b) enables a hole to be punched out more accurately. Further, the shape of the end part 15a, as shown in FIG. 6(a) to (e) viewing the end part 15a from the front, may be made any desired shape such as a circular shape, square shape, triangular shape, rectangular shape, or diamond shape. Of course, it may also be a heart shape or four leaf clever shape or other shape comprised of curved contours. The hole pattern can be made one forming holes of the above shapes on the processed sheet 21 by providing them at a predetermined pitch to the top, bottom, left, and right or at suitable different pitches or by providing them at predetermined intervals in several lines extending in a slanted direction having a desired slant. Of course, the pattern is not limited.

Further, the depth of the hole part at the center of the recessed part 15h and the length (height) of the tip part are suitably selected according to the thickness of the processed sheet 21 forming the hole pattern or the size of the holes etc. Note that, the size of one hole was generally preferably φ1.2 mm or more. Further, the distance between two projecting parts 15, corresponding to the interval between adjoining holes, was preferably 4 mm or more.

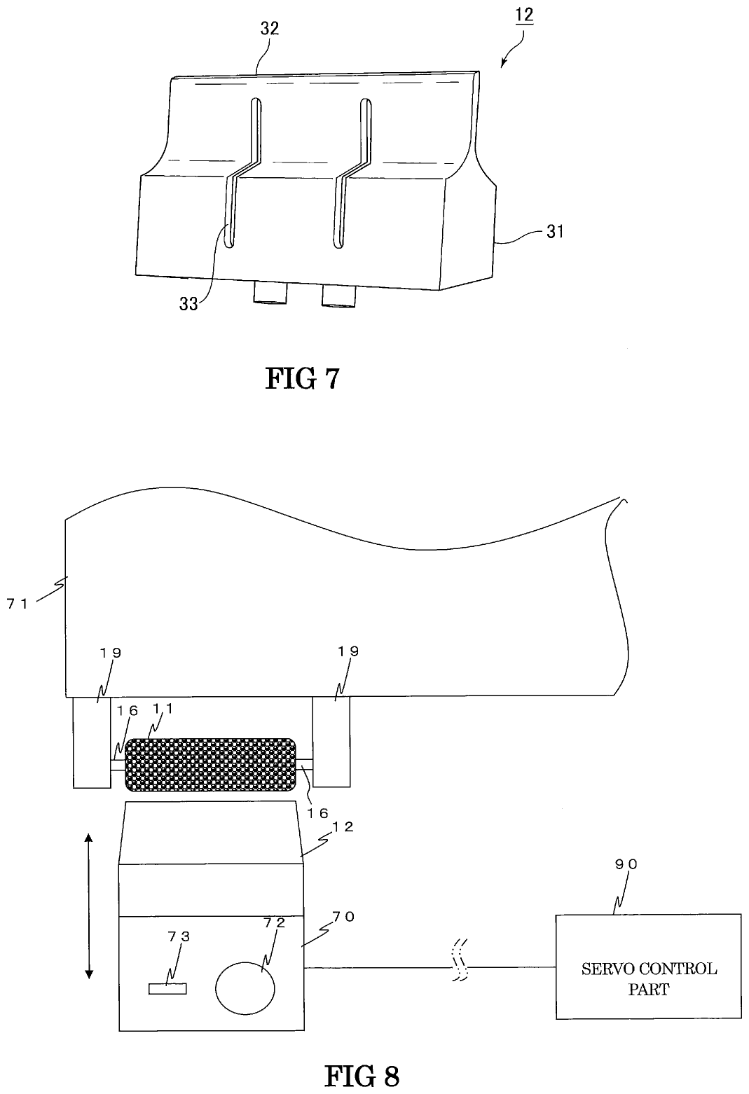

The ultrasonic horn 12, as shown in FIG. 7, is provided with a box shaped base part 31 and a box shaped output part 32 formed above it continuously. Slits 33 are formed from the base part 31 toward the output part 32 side passing through from the front surface side to the back surface and induce the occurrence of torsional vibration due to the ultrasonic waves.

The basic length die 11 and ultrasonic horn 12 are adjusted in position by the configuration shown in FIG. 8. In this example, a single set of the basic length die 11 and ultrasonic horn 12 is shown, but a plurality of other sets may also be similarly configured. The basic length die 11 is attached through a shaft 16 to a bearing 19 attached to an iron plate 71 at a main body with a total weight of 600 kg provided above it. Therefore, the basic length die 11 is provided at an immobilized position. The bearing 19, as shown in FIG. 2, is turned by the chain 18, but here the chain 18 is omitted.

Below the basic length die 11, the ultrasonic horn 12 is provided. Below the ultrasonic horn 12, a servo-type elevator mechanism 70 is provided. At the servo-type elevator mechanism 70, an AC servo motor 72 is provided. Due to operation of the AC servo motor 72, a not shown elevator mechanism part makes the servo-type elevator mechanism 70, oscillator 13, and. ultrasonic horn 12 move up and down to adjust the positions.

At the servo-type elevator mechanism 70, a sensor 73 is provided for detecting the amount of operation of the AC serve motor 72. A signal of the sensor 73 is sent to a servo control part 90 provided at the apparatus main body. 90 receives the input of positional adjustment information from an operator and sends an operation control signal for the AC servo motor 72 to the AC servo motor 72 based on the signal sent from the sensor 73. In accordance with this, the AC servo motor 72 operates by the required amount and the not shown elevator mechanism part makes the oscillator 13 and ultrasonic horn 12 move up and down by exactly the required amounts. As a result, the gap between the ultrasonic horn 12 and the basic length die 11 can be set as desired. In this way, in the present embodiment, position control of the basic length die 11 and the ultrasonic horn 12 are performed by making the ultrasonic horn 12 move in a state with the basic length die 11 immobilized. Due to this, compared with the case of making the basic length die 11 move, suitable position control, including situations where, due to the heat generated by the ultrasonic vibration, the ultrasonic horn 12 expands and pushes up the basic length die 11 causing trouble in ultrasonic punching, becomes possible. Further, for positional control of the ultrasonic horn, instead of using an AC servo motor 72, the above positional control can be performed by driving the horn using compressed air.

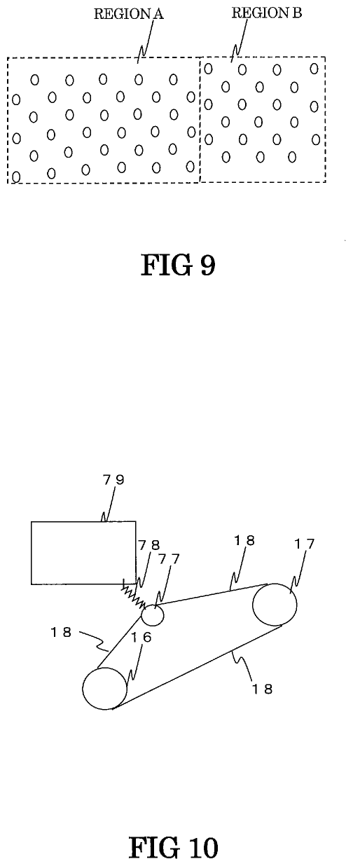

In the present embodiment, a plurality of basic length dies 11, as shown in FIG. 2, are arranged zigzag in the width direction of the processed sheet 21 with end parts slightly overlapping. For this reason, sometimes the hole pattern formed by the overlapping adjoining basic length dies 11 will deviate in the vertical direction such as shown in the region A and region B of FIG. 9. It was able to be pinpointed that this deviation was mostly caused by loose tension of the chain 16.

Therefore, in the present embodiment, a tension adjusting means is provided for adjusting the tension of the chain. Specifically, as shown in FIG. 10 showing the drive shaft 17, chain 18, and shaft 16 of the basic length die 11 in vertical cross-section, a columnar shaped tension adjusting rod 77 having a circumferential surface with no surface relief is provided so as to pass through the insides of the ring of the chain 18. One end part of the tension adjusting red 77 is, for example, loosely attached to the inside part of the side walls of the apparatus main body. At the other end part of the tension adjusting rod 77, a spring 78 is connected. This spring 78 is connected to a top plate part 79 of the conveyor path of the apparatus main body.

For this reason, the tension adjusting rod 77 functions so as to pivot about one end side loosely connected to the apparatus main body so that the other end part to which the spring 78 is connected pulls the chain 18 from the inside to the outside and thereby prevents the tension of the chain 18 from loosening. Due to this, it is possible to prevent the situation of the hole pattern deviating in the vertical direction such as in FIG. 9.

Due to the above constitution, the holes of the hole pattern are melted through by the ultrasonic vibration and the holes of the hole pattern are individually beautifully and reliably formed, so the punching work can be reliably performed. In this case, the circumferential surfaces of the holes formed are melted once by the ultrasonic vibration, then immobilized and therefore a processed sheet can be obtained in which a hole pattern is accurately formed.

As shown in FIG. 1, at one side across from the basic length die 11 and the ultrasonic horn 12, a stock roller 35 at which a processed sheet 21 before being ultrasonically punched is wound is provided. Further, below the stock roller 35 at a position close to the ultrasonic horn 12, a resin sheet roller 42 around which a resin sheet 22 is wound for catching and recovering pieces of the processed sheet 21 punched out from the holes is provided.

The resin sheet 22 is superposed at the bottom of the processed sheet 21 and sent between the basic length die 14 and ultrasonic horn 12 at the position where the conveyor roller 48 is provided from the conveyance path where the processed sheet 21 reaches between the basic length die 11 and the ultrasonic horn 12. The processed sheet 21 is ultrasonically punched between the basic length die 11 and the ultrasonic horn 12 and fed out from between these. The processed sheet 21 and the resin sheet 22 are sandwiched between the holding rollers 43, 44 and further conveyed to the front.

Separating rollers 45U, 45D are provided at the front of the holding rollers 43, 44 in the conveyance direction. The resin sheet 22 and the processed sheet 21 conveyed from the holding rollers 43, 44 are separated by the separating rollers 45U, 45D. That is, the processed sheet 21 and the resin sheet 22 are separated into two before reaching the separating rollers 45U, 45D after which the processed sheet 21 superposed at the top is made to contact the separating roller 45U and thereby reach a product takeup roller 46. Further, the resin sheet 22 superposed at the bottom circles part of the separating roller 45D and is taken up by the recovered sheet roller 47 through the rollers 52, 53. Above the rollers 52, 53, a scaffolding board 51 used at the time of inspection etc. is provided in a state not interfering with rotation of the rollers 52, 53. In the above, the component elements provided at the front side of the holding rollers 43, 44 in the conveyance direction form the punching recovery and conveyance mechanism 40 for separating the resin sheet 22 and the processed sheet 21.

Further, the conveyance path from the stock roller 35 and the resin sheet roller 42 to between the die 11 and the ultrasonic horn 12, the basic length die 11, ultrasonic horn 12, oscillator 13, and ultrasonic transducer 14, as explained above, function as the punching part 10 for running the processed sheet. 21 and resin sheet 22 between the basic length die 11 and the ultrasonic horn 12 for punching by irradiation by ultrasonic waves.

In the ultrasonic punching apparatus configured as explained above, the processed sheet 21 of the stock roller 35 and the resin sheet 22 wound around the resin sheer, roller 42 are guided through the conveyance path to between the die basic length die 11 and the ultrasonic horn 12 and run between them for irradiation by ultrasonic waves for ultrasonic punching.

Due to the above configuration, in the superposed processed sheet 21 and resin sheet 22, at the time of the above ultrasonic punching, holes of the hole pattern of the processed sheet 21 are melted through by the ultrasonic vibration. At the resin sheet 22 as well, parts corresponding to the holes in the hole pattern of the processed sheet 21 are melted by ultrasonic vibration. At this time, the pieces of the processed sheet 21 punched out from the holes are melt bonded and solidified with the superposed resin sheet 22 right after the resin sheet 22 is fuel melted by the ultrasonic vibration and thereby immobilized. In this state, the resin sheet 22 and the processed sheet 21 are conveyed by the holding rollers 43, 44 in the direction of the product takeup roller 46 and recovered sheet roller 47 and are separated in the process of being guided to the separating rollers 45U, 45D.

After separation by the separating rollers 45, the pieces of the processed sheet 21 punched out from the holes are conveyed together with ther resin sheet 22 as deposited on the resin sheet 22. On the other hand, the processed sheet 21 from which the pieces of the processed sheet 21 punched out from the holes are removed by being taken away by the resin sheet 22 is taken up by the product takeup roller 46 while the resin sheet 22 on which the pieces are stuck is taken up by the recovered sheet roller 47.

Therefore, punched out pieces will never remain in the holes of the hole pattern at the processed sheet 21 or form debris sticking to other portions of the processed sheet 21, so it is possible to obtain a processed sheet 21 in a state with the hole pattern accurately formed.

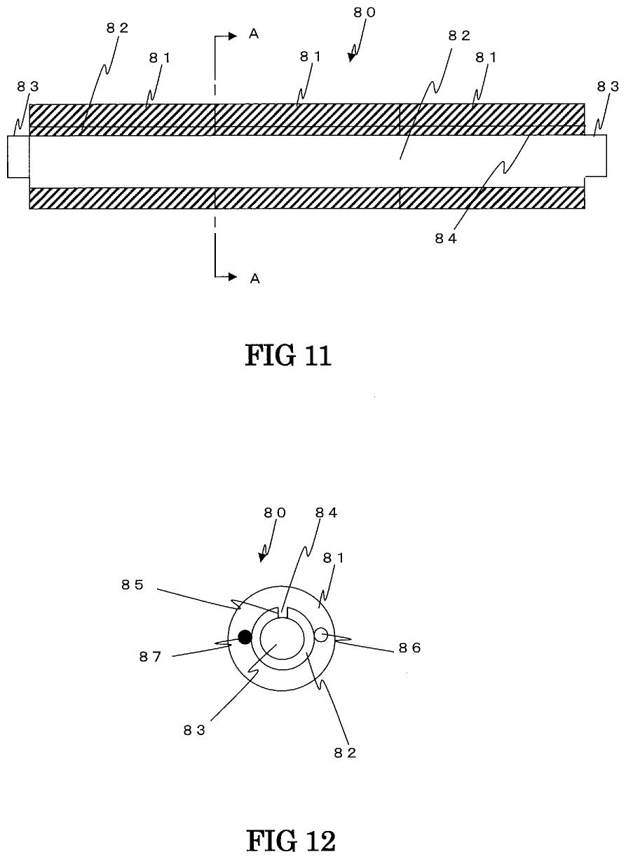

In the above embodiment, as shown in FIG. 2, a plurality of the above basic length dies 11 were arranged aligned in the width direction of the processed sheet 21, but it is possible to combine a plurality of basic length dies 11 in the length direction to obtain an NX length die. FIG. 11 and FIG. 12 show an N=3 3X length die 80. FIG. 11 is a cross-sectional view in the length direction of the 3X length die 80 used in the second embodiment, while FIG. 12 is a cross-sectional view along the line A-A of FIG. 11.

The 3X length die 80 has a single columnar shaped shaft member 82 at the center of the length direction. The length of the shaft member 82 may be made about 3X the length of the shaft of the basic length die 11. The two end parts of the shaft member 82 fora shaft ends 83 with smaller diameters than the center part. At the outer circumference of the shaft member 82, three basic length die parts 81 are provided connected with each other in series. One basic length die part 81 is substantially the sane in length as the basic length die 11, forms a cylindrical shape, and is formed on its surface with projecting parts corresponding to the hole pattern. At the inside wall of the basic length die part 81, one projecting ridge 84 is formed.

At the outer circumference of the shaft member 82, one recessed groove 65 corresponding to the projecting ridge 84 is formed. If mating the projecting ridge 84 of the basic length die part 81 with the recessed part 85 of the outer circumference of the shaft member 82 to enable movement in the axial direction, the projecting ridge 84 can slide inside the recessed part 85 to thereby join the two.

At the end part of one on basic length die part 81 adjoining which another basic length die part 81 is provided, a tenon 86 sticking out to the other and a mortise 87 receiving and mating with a tenon 86 extending from the end part of the corresponding basic length die part 81 are formed. Here, one each tenon 86 and mortise 87 is provided, but the invention is not limited to this number. When connecting three adjoining basic length die parts 81 by tenons 86 and mortises 87, at the surfaces of the three basic length die parts 81, projecting parts corresponding to the hole pattern are arranged on the surfaces so that no deviation occurs. The positions of the three basic length die parts 81 in the axial direction can be adjusted by positioning the end faces of the basic length die parts 81 at the end side with the boundary positions of the shaft ends 83.

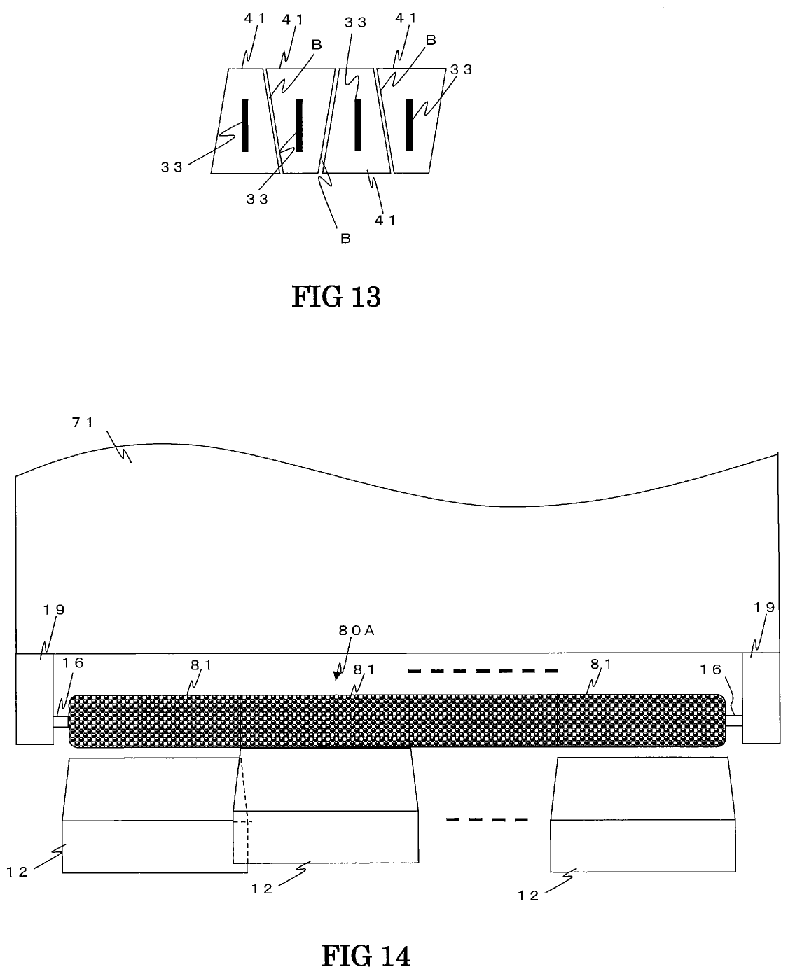

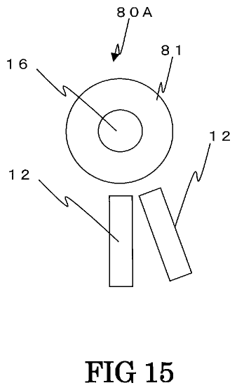

In the second embodiment, the ultrasonic horn 12 is configured as shown in FIG. 13 in the state seen from the front direction. That is, as the ultrasonic horn 12, a plurality of sectional ultrasonic horns 41 having ultrasonic output tips shorter than the ultrasonic output tip length of the ultrasonic horn 12 are arranged aligned corresponding to the basic length die 81. Here, this is divided into four sections, but the number may be suitably set. These four sectional ultrasonic horns 41 are provided corresponding to one basic length die part 81. Therefore, as shown in FIG. 11, when using three basic length die parts 81 to configure a 3X length die 80, three sets of the four sectional ultrasonic horns 41 shown in FIG. 13 are provided.

The boundaries B of the sectional ultrasonic horns 41 for example have 1 to 2 mm or so gaps and are formed as slanted surfaces such as shown in FIG. 13. In the present embodiment, when viewed from the front, if the first adjoining boundary B is a downward right slanting surface, the next adjoining boundary B is made an upward right slanting surface. The outer edges of four sectional ultrasonic horns 41 provided at the two ends, that is, the outer edges at the sides with no adjoining sectional ultrasonic horns 41, are made slanted surfaces in the present embodiment, but may also be surfaces formed by vertically extending lines. By the boundaries B being made slanted surfaces as explained above, ultrasonic vibration causes the adjoining sectional ultrasonic horns 41 to vibrate and contact each other resulting in climbing or descent at the boundaries B and a mutually joined state being exhibited, so while a plurality of sectional ultrasonic horns 41, a uniform ultrasonic wave is output like with a single ultrasonic horn and even ultrasonic punching is performed.

At each sectional ultrasonic horn 41, as explained in FIG. 1, an oscillator 13 is connected. At this oscillator 13, an ultrasonic transducer 14 sending high frequency electric power of a predetermined frequency to the oscillator 13 is connected. Due to this configuration, electric power the same as the electric power supplied to one ultrasonic horn 12 shown in FIG. 1 is supplied to each sectional ultrasonic horn 41 and the same power is used to output ultrasonic waves. Therefore, according to the present embodiment, it is possible to form an accurate hole pattern.

By using an ultrasonic horn 12 configured by a plurality of sectional ultrasonic horns 41 in this way, 2 larger power ultrasonic vibration than the past is created to melt and punch out the holes of the hole patterns the holes of the hole pattern can be individually beautifully reliably formed, and the punching operation can be reliably performed. Further, the circumferential surfaces of the holes formed melted once by ultrasonic vibration to be fastened or immobilized whereby a processed part in a state with the hole pattern reliably formed can be obtained.

FIG. 14 shows the configuration of the part, of the ultrasonic horn and die in the ultrasonic punching apparatus according to the third embodiment. In the present embodiment, an NX length die 80A is used. That is, it is configured by N number of basic length die parts 81 linked together. The length of the NX length die 80A is substantially equal to the width of the processed sheet 21. The single NX length die 80A is used for the ultrasonic processing. One ultrasonic horn 12 is provided for the basic length die parts 81. A total of N number of ultrasonic horns 12 are therefore provided. The ultrasonic horns 12 are configured in the same way as explained in FIG. 7.

However, adjoining ultrasonic horns 12 have parts aligned with and overlapping the processed sheet 21 in the width direction, so as shown in FIG. 14, the adjoining ultrasonic horns 12, 12 are arranged at the circumferential surface of the basic length die part 81 positioned at different arc-shaped parts. The rest of the configuration is equal to the configuration of the first embodiment. Even by this thus configured third embodiment, the circumferential surfaces of the holes formed are immobilized and a processed sheet can be obtained in the state with the hole pattern formed accurately. Note that, the ultrasonic horn 12 of the present embodiment may of course also be made an ultrasonic horn configured by a plurality of sectional ultrasonic horns 41 used in the second embodiment.

### EXPLANATION OF REFERENCES

10. punching part

11. die

12. ultrasonic horn

13. oscillator

14. ultrasonic transducer

16. shaft

17. drive shaft

18. chain

19. bearing

21. processed sheet

22. resin sheet

31. base part

32. output part

33. slit

35. stock roller

40. punching recovery arid conveyance mechanism

41. sectional ultrasonic horn

42. resin sheet roller

43, 48. roller

45U, 45D. separating roller

46. product takeup roller

47. recovered sheet roller

70. servo-type elevator mechanism

77. tension adjusting rod

78. spring

79. top plate part

80. 3x length die

80A. NX length die

90. servo control part

1. An ultrasonic punching apparatus comprising:
a die on a surface of which are formed projecting parts corresponding to a hole pattern to be added to a processed sheet,
an ultrasonic horn provided facing said die and outputting an ultrasonic wave toward a surface of said die,
a punching part superposing over said processed sheet a resin sheet for melt bonding with and recovering pieces of said processed sheet punched out from the holes, passing the sheets between said die and said ultrasonic horn, and outputting an ultrasonic wave from said ultrasonic horn toward said die to perform punching, and
a conveyor mechanism, separating the resin sheet and said processed sheet after passage.

2. An ultrasonic punching apparatus according to claim 1, further comprising a drive source driving said ultrasonic horn so that due to the ultrasonic waves output toward the projecting parts of said die, the portions corresponding to the projecting parts of said die are melted through in a hole pattern, the tips of the projecting parts of said die are thin substantially rod shaped, and the ends are configured flat.

3. An ultrasonic punching apparatus according to claim 1 wherein a plurality of sets of a basic length die of a length shorter than a width of said processed sheet and an ultrasonic horn of a length corresponding to this basic length die are arranged aligned in a width direction of said processed sheet.

4. An ultrasonic punching apparatus according to claim 3, wherein the sets of said basic length die and said ultrasonic horn are arranged zigzag in a direction in which said processed sheet is conveyed.

5. An ultrasonic punching apparatus according to claim 3, further comprising a tension adjusting means provided with a rotating mechanism using a chain connected to a drive shaft to make said basic length die rotate and adjust a tension of said chain.

6. An ultrasonic punching apparatus according to claim 1 wherein positional control of said die or said basic length die and said ultrasonic horn is performed by making said ultrasonic horn move in a state where said die or said basic length die is immobilized.

7. An ultrasonic punching apparatus according to claim 3, wherein a plurality of said basic length dies are combined in a length direction to form an NX length die.

8. An ultrasonic pinching apparatus according to claim 3, wherein as said ultrasonic horn, a plurality of sectional ultrasonic horns having ultrasonic output tips shorter than the ultrasonic output tip length of said ultrasonic horn are arranged corresponding to said basic length die.

9. An ultrasonic punching apparatus according to claim 8, wherein boundaries of divided sectional ultrasonic horns are formed as slanted surfaces.

10. An ultrasonic punching method comprising
running between a die on a surface of which are formed projecting parts corresponding to a hole pattern to be added to a processed sheet and an ultrasonic horn provided facing said die and outputting an ultrasonic wave toward a surface of said die,
a resin sheet for melt bonding with and recovering pieces of said processed sheet punched out from the holes superposed on said processed sheet,
outputting ail ultrasonic wave from said ultrasonic horn toward said die to perform punching when said superposed processed sheet and resin sheet are passed between said die and said ultrasonic horn, and
separating said resin sheet and said processed sheet after passing between said die and said ultrasonic horn.

11. An ultrasonic punching method according to claim 10, further comprising driving said ultrasonic horn so that due to the ultrasonic waves output toward the projecting parts of said die, the portions of said sheet corresponding to the projecting parts of said die and the corresponding portions of said resin sheet are melted through in a hole pattern.

12. An ultrasonic punching method according to claim 10, further comprising arranging a plurality of sets of a basic length die of a length shorter than a width of said processed sheet and an ultrasonic horn of a length corresponding to this basic length die aligned in a width direction of said processed sheet and outputting ultrasonic waves from the respective ultrasonic horns toward the surfaces of corresponding basic length dies.

13. The ultrasonic punching method according to claim 12, wherein as said ultrasonic horn, a plurality of sectional ultrasonic horns having ultrasonic output tips shorter than the ultrasonic output tip length of said ultrasonic horn are arranged corresponding to said basic length die.
